(19) United States
(12) Patent Application Publication
(10) Pub. No.: US 2026/0045008 A1
(43) Pub. Date: Feb. 12, 2026

(54) MULTI-CONCEPT FUSION IN TEXT-TO-IMAGE MODELS

(71) Applicant: ADOBE INC., SAN JOSE, CA (US)

(72) Inventors: Fabian David Caba Heilbron, San Jose, CA (US); Gihyun Kwon, Seoul (KR); Joon-Young Lee, San Jose, CA (US); Simon Jenni, Hagendorf (CH); Dingzeyu Li, Sammamish, WA (US)

(21) Appl. No.: 18/795,943

(22) Filed: Aug. 6, 2024

(51) Int. Cl. G06T 11/60; G06T 7/11

(52) U.S. Cl. CPC G06T 11/60; G06T 7/11; G06T 2207/20081; G06T 2207/20084; G06T 2207/20221; G06T 2210/52

(57) ABSTRACT

A method, apparatus, non-transitory computer readable medium, and system for image generation includes obtaining an input prompt including a first image element and a second image element. The image generation model generates first image features representing the first image element using a first layer selected based on the first image element and second image features representing the second image element using a second layer selected based on the second image element, wherein the second layer is selected based on the second image element. A synthetic image is generated including the first image element and the second image element based on the first image features and the second image features.

### BACKGROUND

The following relates generally to machine learning, and more specifically to image generation using a machine learning model. Machine learning algorithms build a model based on sample data, known as training data, to make a prediction or a decision in response to an input without being explicitly programmed to do so. One area of application for machine learning is image generation.

For example, a machine learning model can be trained to predict features for an image in response to an input prompt, and to then generate the image based on the predicted features. In some cases, the prompt can be used to perform complex image manipulation and compositing. Such image generation provides for a user to edit an image and generate an image with desired features and therefore makes image generation easier for a layperson.

### SUMMARY

Embodiments of the present disclosure provide an image processing system that includes an image generation model for performing a multi-concept fusion in text-to-image models. According to an embodiment, the image generation model is configured to generate a customized image based on an input text prompt. For example, the generated customized image includes a plurality of custom concepts. In some cases, the image generation model creates the customized image that aligns with the semantics of the input prompt, and uses a cross-attention module to perform fusion with custom concepts.

A method, apparatus, and non-transitory computer readable medium for image processing are described. One or more aspects of the method, apparatus, and non-transitory computer readable medium include obtaining a first image element and a second image element; generating, using a first layer of an image generation model, first image features representing the first image element, wherein the first layer is selected based on the first image element; generating, using a second layer of the image generation model, second image features representing the second image element, wherein the second layer is selected based on the second image element; and generating, using the image generation model, a synthetic image including the first image element and the second image element based on the first image features and the second image features.

A method, apparatus, and non-transitory computer readable medium for image processing are described. One or more aspects of the method, apparatus, and non-transitory computer readable medium include obtaining a training set including a first image depicting a first image element and a second image depicting a second image element and training, using the training set, the image generation model to generate a synthetic image including the first image element and the second image element, the training comprising: training a first layer of the image generation model to generate features representing the first image element using the first image in a first training phase, and training a second layer of the image generation model to generate features representing the second image element using the second image in a second training phase.

An apparatus and system for image processing are described. One or more aspects of the apparatus and system include an image generation model configured to select a first layer of an image generation model based on a first image element, generate, using the first layer, first image features representing the first image element, select a second layer of an image generation model based on a second image element, generate, using a second layer of the image generation model, second image features representing a second image element of the input prompt, and generate a synthetic image including the first image element and the second image element based on the first image features and the second image features.

### BRIEF DESCRIPTION OF THE DRAWINGS

FIG. 1 shows an example of an image processing system according to aspects of the present disclosure.

FIG. 2 shows an example of a method for generating a customized image according to aspects of the present disclosure.

FIG. 3 shows an example of an image customization process according to aspects of the present disclosure.

FIG. 4 shows an example of an image processing apparatus according to aspects of the present disclosure.

FIG. 5 shows an example of an image generation model according to aspects of the present disclosure.

FIG. 6 shows an example of an image inversion process according to aspects of the present disclosure.

FIG. 7 shows an example of a latent diffusion architecture according to aspects of the present disclosure.

FIG. 8 shows an example of a combination process according to aspects of the present disclosure.

FIG. 9 shows an example of a method for image processing according to aspects of the present disclosure.

FIG. 10 shows an example of a method for training an image generation model according to aspects of the present disclosure.

FIG. 11 shows an example of training a diffusion model according to aspects of the present disclosure.

FIG. 12 shows an example of a computing device according to aspects of the present disclosure.

### DETAILED DESCRIPTION

The present disclosure describes an image generation model for performing a multi-concept fusion. According to an embodiment, the image generation model generates a customized image based on multiple custom image elements. (e.g., a user's own cat and dog). In some cases, the image generation model creates an image including the customized elements in a scene described by an input prompt.

Machine learning models are used to customize an image and are thus useful for several image generation and editing applications. However, existing methods do not accurately perform the task of multi-concept fusion. That is, conventional image generation models are not able to produce customized images including multiple custom concepts while preserving the semantics of the image. These models tend to generate images with merged or missing concepts. For example, the result does not retain the identity of the custom concepts, or it does not include all of the elements of a described scene.

Additionally, conventional methods dop not accurately generate a semantically meaningful image when there are concept-to-concept interactions such as hugging, kissing, or holding hands. Therefore, conventional image generation models do not consistently provide images where multi-concept fusion is efficiently and consistently achieved while providing a semantically meaningful interaction.

Embodiments of the disclosure improve on conventional image generation models by more accurately and consistently generating images with multiple custom elements. To achieve the increased accuracy, an image generation model uses different layers trained for each specific custom concept. In some cases, features from a template image are combined with features representing the custom objects. An embodiment of the present disclosure includes multiple cross-attention layers that combine features of different masked regions associated with each concept. Additionally, embodiments of the disclosure generate images that accurately depict close interactions between generated custom concepts.

Embodiments of the present disclosure include an image generation model that generates multiple custom concepts in an image with a given input prompt. In some cases, the image generation model composes custom concepts from a custom category (e.g., a bank of concepts) at inference time. An embodiment of the disclosure includes a two stage pipeline that generates a template image based on the prompt and then fuses the custom concepts while leveraging region guidance that enables identification of bounding boxes for the concepts in the image. According to an embodiment, a diffusion model is used to generate a synthetic (e.g., output) image with the desired (i.e., custom) concepts.

In some cases, the image generation model generates customized (e.g., personalized images) from an input text prompt. In some cases, the input text prompt includes a plurality of custom concepts. By generating a customized image based on the received text prompt, embodiments of the present disclosure are able to provide users with an ability to compose coherent and consistent visual images including a plurality of concepts comprising elements (i.e., characters or subjects) and background (i.e., locations).

One or more embodiments of the present disclosure are configured to perform a multi-concept image generation process. In some cases, a template image is generated based on the input prompt and then target/custom concepts are incorporated into the template image by using models that each correspond to individual custom concepts. In some cases, the multi-concept fusion process is spatially guided via mask regions extracted from the template image.

Embodiments of the present disclosure are configured to perform a multi-concept fusion process to generate a customized image. In some examples, the customized image is generated that depicts an interaction between three concepts, i.e., elements and background, e.g., [fido] a dog, [Fabian] a person, and [backyard] a backyard, where text within a bracket [ ] indicates a custom concept. In some cases, each of the concepts such as dog and person indicate elements and a concept such as backyard indicates background. In some cases, the image generation model is trained for each of the custom concepts to generate a custom category or a bank of concepts. In some examples, a custom diffusion model is used to train the image generation model.

In some cases, a template image, i.e., a generalized image, is generated based on the received prompt using a text-to-image model. For example, in case of a prompt such as “[fido] and [fabian] running in the [backyard]”, the template image is generated based on replacing custom concepts with the corresponding semantic classes. In some cases, a prompt such as “dog and man running in the backyard” is provided to the text-to-image model to generate the template image.

An embodiment of the present disclosure is configured to extract template features from the template image. In some cases, a denoising diffusion implicit model (DDIM) inversion process is implemented to capture the spatial composition of the image. In some cases, spatial masks are extracted from the template image for each of the concepts (i.e., elements and background).

According to an embodiment, a multi-concept fusion process uses an inverted latent from the DDIM process and denoises the noisy image with fine-tuned models from the concept category (e.g., concept bank). In some cases, after obtaining multiple cross-attention layer features, the image generation model fuses different features from each mask region. In some cases, the image generation model incorporates or injects the template features into the network based on a cross attention mechanism to generate combined features. Accordingly, a custom image is generated based on the combined features, which depicts a custom dog and a custom person running in the backyard.

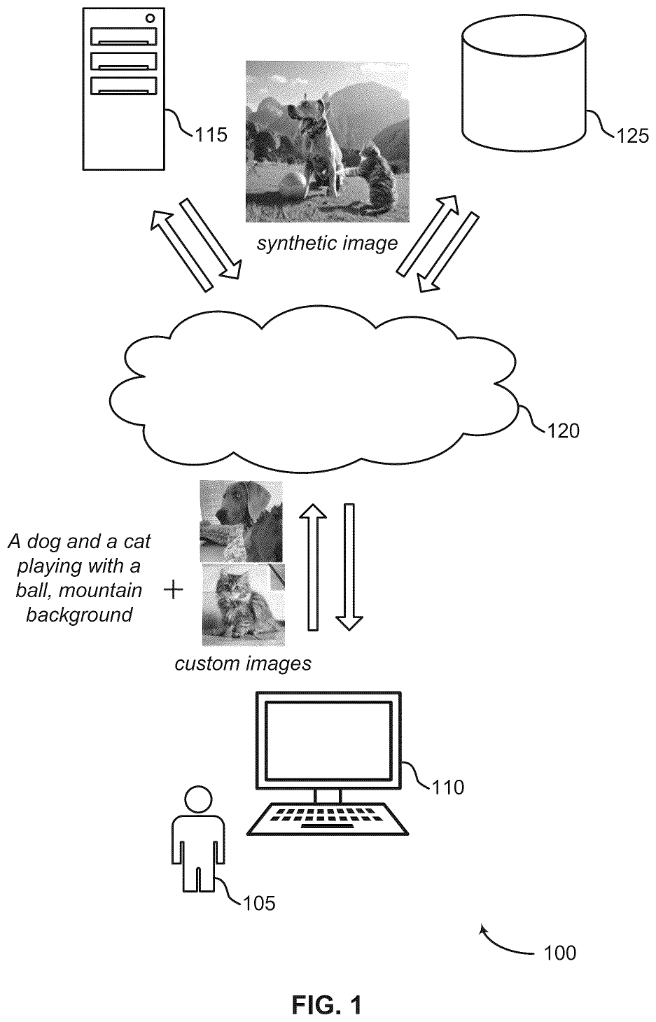

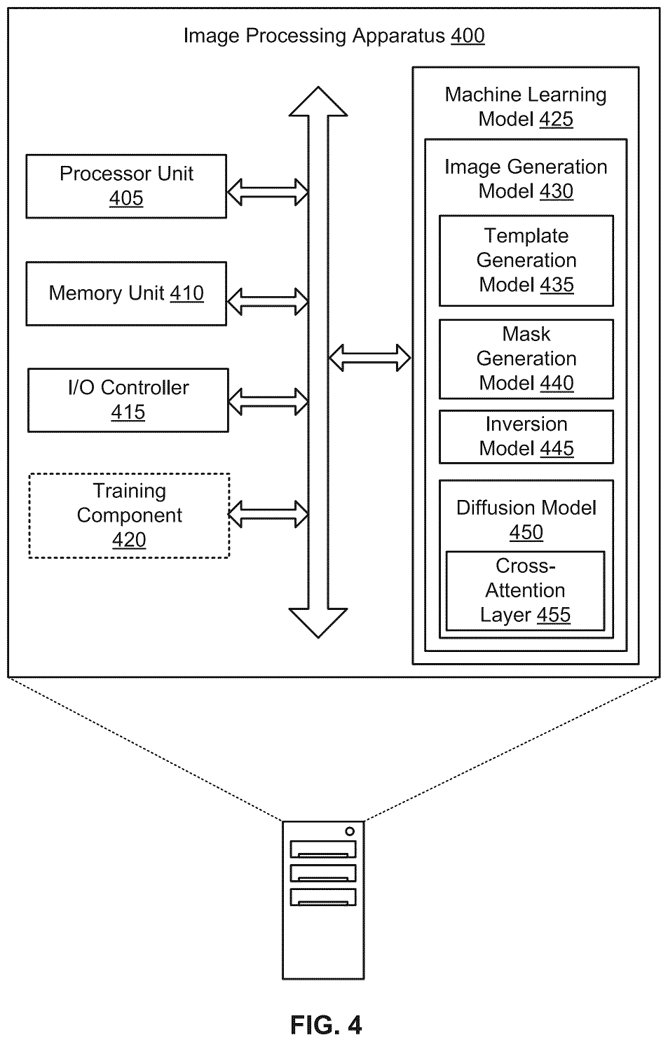

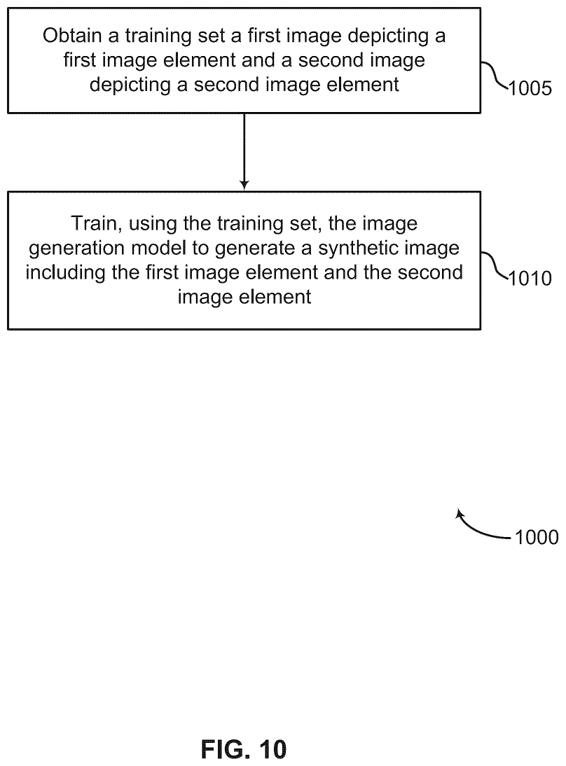

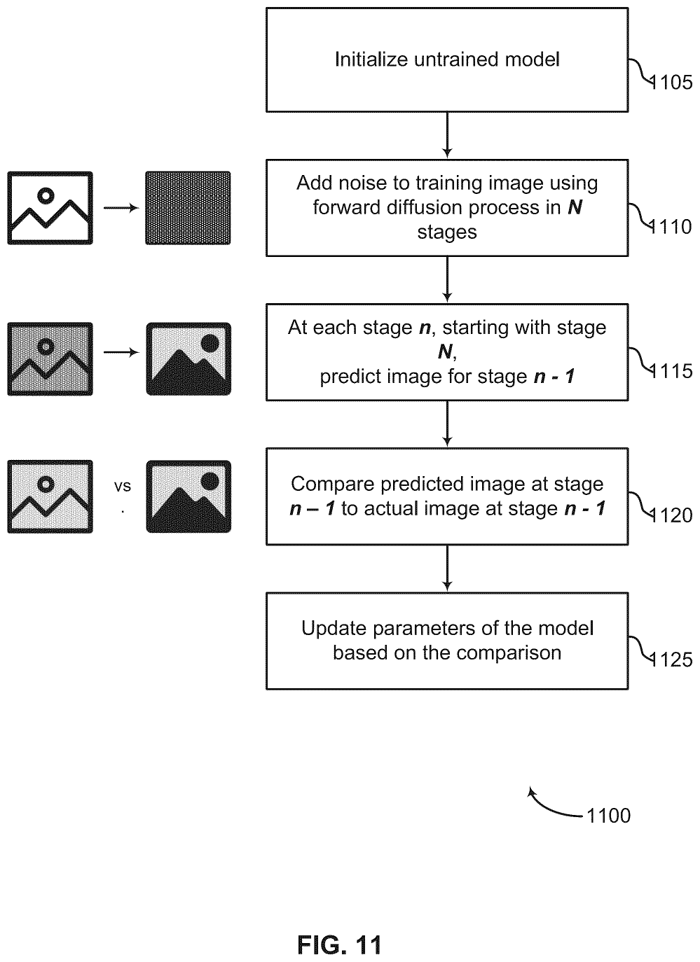

Embodiments of the present disclosure can be used in the context of image generation applications. For example, an image generation network based on the present disclosure takes a prompt (e.g., text-based prompt) and a custom image corresponding to a concept as input and efficiently generates a customized image. Example applications regarding generating an image that depicts multiple similar concepts with desired interactions are provided with reference to FIGS. 1-3 and 9. Details regarding the architecture of the image generation system are provided with reference to FIGS. 4-8 and 12. Examples of a process for training an image generation model are provided with reference to FIGS. 10-11.

### Image Generation System

A system and an apparatus for image processing are described with reference to FIGS. 1-8. FIG. 1 shows an example of an image processing system 100 according to aspects of the present disclosure. In one aspect, image processing system 100 includes user 105, user device 110, image processing apparatus 115, cloud 120, and database 125.

In the example of FIG. 1, user 105 provides an input prompt to image processing apparatus 115 via a user interface provided on user device 110 by image processing apparatus 115. In some cases, the input prompt is a text input. As used herein, “text input” refers to a text prompt provided by a user to generate a desired image. As an example shown in FIG. 1, the user provides a text prompt that describes aspects of the image the user wants to generate using the image processing apparatus 115 of the present disclosure. According to some aspects, image processing apparatus 115 obtains an input prompt including a first image element and a second image element (e.g., dog and cat).

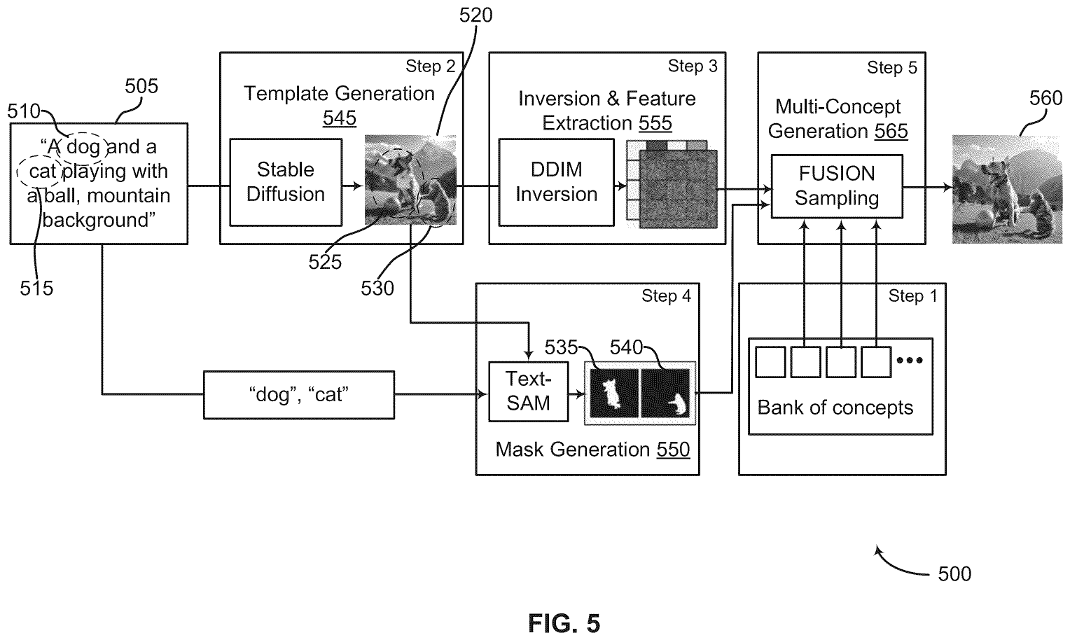

In some cases, the image processing apparatus 115 uses an image generation model (such as the image generation model described with reference to FIGS. 4-5) to generate an output image (e.g., synthetic image) based on the text prompt. In some cases, as shown in FIG. 1, the user may, based on the text prompt, provide a custom image (i.e., depicting a particular element of the text prompt, e.g., the user's dog or the user's cat, etc.). In some cases, the image processing apparatus 115 generates a synthetic image that incorporates the particular element depicted in the custom image into the output image. In some cases, the image generation model is trained based on an input image (e.g., based on the process described with reference to FIGS. 10-11), such that the image generation model learns to generate images that include custom elements (e.g., custom elements that are part of custom images).

Referring to the example of FIG. 1, the image processing apparatus 115 provides the output image to user 105 via the user interface provided on user device 110. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as images (custom images or synthetic image), a prompt, etc.) to be communicated between user 105 and image processing apparatus 115. Image processing apparatus 115 is an example of, or includes aspects of, the corresponding element described with reference to FIG. 4.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

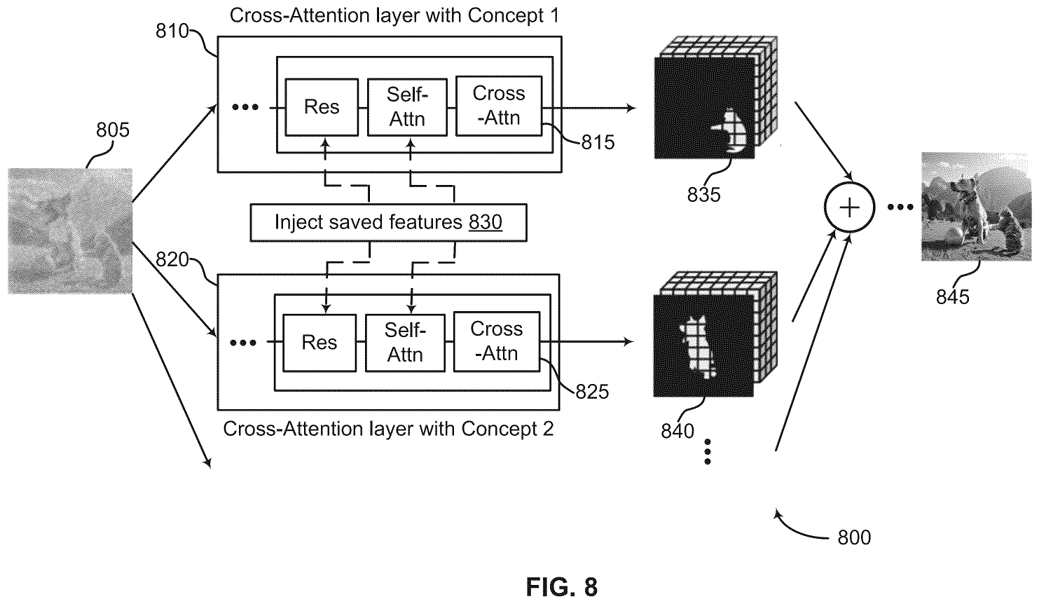

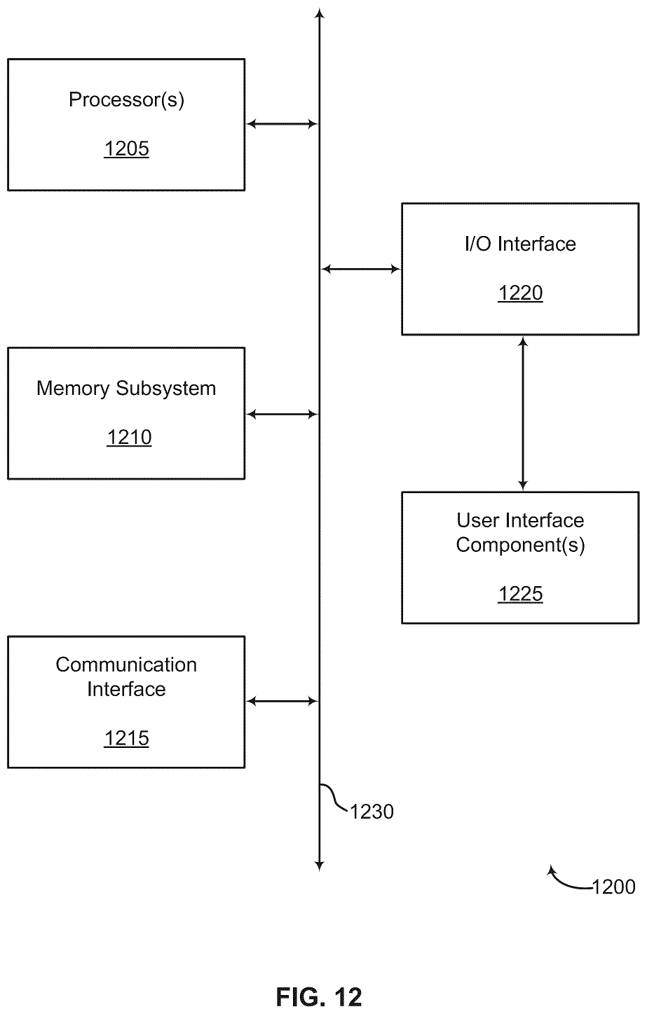

Image processing apparatus 115 is an example of, or includes aspects of, the corresponding element described with reference to FIG. 4. According to some aspects, image processing apparatus 115 includes a computer-implemented network. In some embodiments, the computer-implemented network includes a machine learning model (such as the image generation model described with reference to FIGS. 5 and 8). In some embodiments, image processing apparatus 115 also includes one or more processors, a memory subsystem, a communication interface, an I/O interface, one or more user interface components, and a bus as described with reference to FIG. 12. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

According to some aspects, image processing apparatus 115 obtains an input prompt and a custom image, where the text prompt describes (e.g., an interaction between) a first image element and a second image element, and where the custom image depicts an image of the first image element and an image of the second image element. For example, the custom image depicts a customized image or a particular image of the element (e.g., the first image element and/or the second image element). In some examples, image processing apparatus 115 generates a generalized image (e.g., template image) based on the text prompt, obtains an inpainting mask indicating a region for the first image element and the second image element in the template image, and generates a synthetic image based on the masked region and the custom image.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

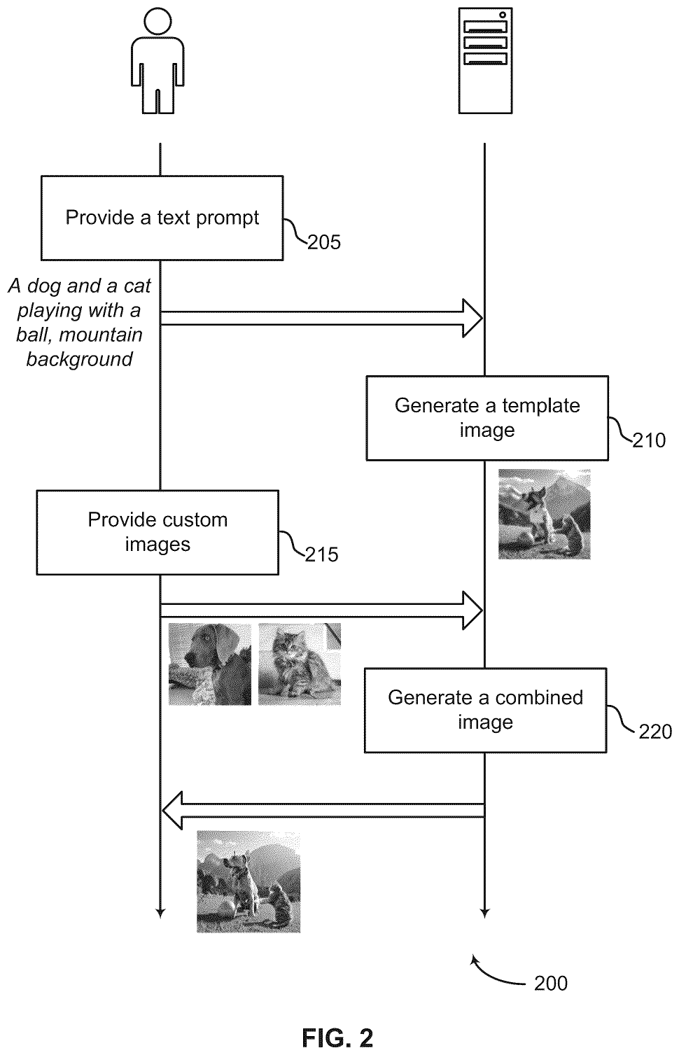

FIG. 2 shows an example of a method 200 a method for generating a customized image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to an embodiment of the present disclosure, an image processing apparatus (such as the image processing apparatus described with reference to FIGS. 1 and 4) provides an image generation model (such as the image generation model described with reference to FIGS. 4-6 and 8) that is trained based on a training image including a plurality of custom elements (using a training process described with reference to FIG. 10) to generate an image representing a desired custom element.

At operation 205, the system provides a text prompt. In some cases, the operations of this step refer to, or may be performed by, a user, such as the user described with reference to FIG. 1. In some examples, the user provides a text prompt to the image processing apparatus (such as the image processing apparatus described with reference to FIG. 1). As shown in FIG. 2, the text prompt includes a plurality of elements that the user may want to customize. For example, the user may want the output image to include a customized image of the “dog” and “cat” specified in the text prompt. In some cases, the user provides the text prompt to the image processing apparatus via a user interface (such as a graphical user interface) provided on a user device by the image processing apparatus.

At operation 210, the system generates a template image. In some cases, the operations of this step refer to, or may be performed by, the image processing apparatus as described with reference to FIG. 4. In some cases, the image processing apparatus generates the template image based on the text prompt. In some cases, the template image may refer to an image that includes a generalized element of the text prompt. For example, as shown in FIG. 2, the template image includes a non-custom dog and a non-custom cat that are playing with a ball besides a mountain background (as specified in the text prompt obtained in operation 205).

At operation 215, the system provides custom images. In some cases, the operations of this step refer to, or may be performed by, a user, such as the user described with reference to FIG. 1. In some cases, the user provides a set of custom images of the desired elements in the text prompt. For example, as shown in FIG. 2, the user provides a custom image of a dog and a custom image of a cat to the image processing apparatus. In some cases, the user provides each of the custom images to the image processing apparatus via a user interface (such as a graphical user interface) provided on a user device by the image processing apparatus.

At operation 220, the system generates a combined image. In some cases, the operations of this step refer to, or may be performed by, an image processing apparatus as described with reference to FIG. 4.

In some cases, the combined image may refer to an image that incorporates the custom image provided by the user (at operation 215) and the template image generated by the image processing apparatus (at operation 210). For example, as shown in FIG. 2, the combined image includes the dog of the custom image and the cat of the custom image received in operation 215. In some examples, the combined image depicts the custom dog and the custom cat playing with a ball besides a mountain background (as specified in the text prompt in operation 205). In some cases, the combined image is displayed to the user. For example, in some cases, the image processing apparatus displays the combined image to the user via the user interface.

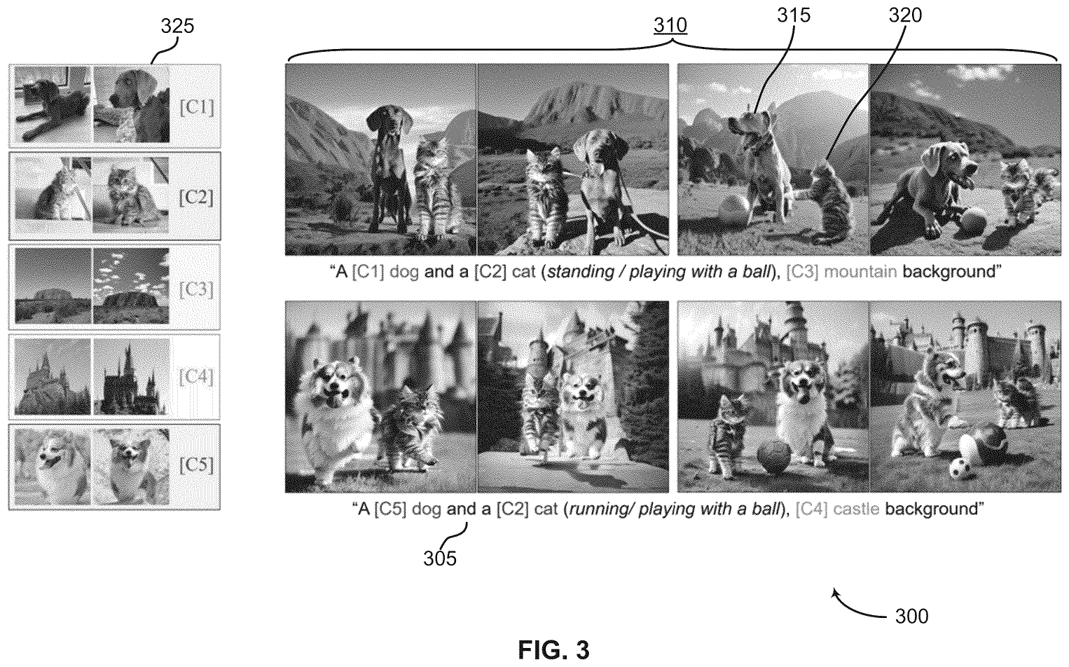

FIG. 3 shows an example of an image customization process 300 according to aspects of the present disclosure. In one aspect, image customization process 300 includes input prompt 305, synthetic image 310, and concept category 325. Input prompt 305 is an example of, or includes aspects of, the corresponding element described with reference to FIG. 5. Concept category 325 is an example of, or includes aspects of, the corresponding element described with reference to FIG. 5.

Synthetic image 310 is an example of, or includes aspects of, the corresponding element described with reference to FIGS. 5 and 8. In one aspect, synthetic image 310 includes first image element 315 and second image element 320. First image element 315 is an example of, or includes aspects of, the corresponding element described with reference to FIG. 5. Second image element 320 is an example of, or includes aspects of, the corresponding element described with reference to FIG. 5.

Referring to FIG. 3, a plurality of synthetic images 310 are generated based on input prompt 305 and concept category 325. For example, input prompt 305 may be a text prompt. In some cases, synthetic image 310 is generated that depicts the text prompt 305. In some cases, text prompt 305 includes first image element 315 and second image element 320. For example, as shown in FIG. 3, text prompt 305 describes an interaction (e.g., standing/playing with a ball or running/playing with a ball) between first image element 315 (i.e., dog) and second image element 320 (i.e., cat). In some examples, text prompt 305 provides a description of a desired background (e.g., a mountain background or a castle background the user wants in the synthetic image 310).

In some cases, synthetic image 310 depicts the first image element 315 and second image element 320 as described in text prompt 305. In some cases, synthetic image 310 represents the interactions (e.g., standing/playing with a ball or running/playing with a ball) described in the text prompt 305. In some cases, synthetic image 310 includes first image element 315 and second image element 320 based on the concept category 325. For example, each of first image element 315 and second image element 320 in synthetic image 310 may depict a particular element stored in the concept category 325.

In some cases, concept category 325 includes a bank of concepts comprising images corresponding to a plurality of concepts. In some examples, the images corresponding to the plurality of concepts in the concept category 325 may be custom images provided by the user (e.g., a user described with reference to FIG. 1, using a process described with reference to FIG. 2). Accordingly, for example, the synthetic image includes customized variants of the first image element and the second image element provided by concept category 325.

Referring to FIG. 3, text prompt 305 states “A [C1] dog and a [C2] cat (standing/playing with a ball), [C3] mountain background”. In some cases, [C1] refers to the images of first image element 315 (e.g., dog) obtained from concept category 325. Additionally, [C2] refers to the images of second image element 320 (e.g., cat) obtained from concept category 325. Additionally, [C3] refers to the images of background (e.g., mountain) obtained from concept category 325. Accordingly, generated synthetic images 310 depict the first and second image elements (e.g., dog obtained from [C1] and cat obtained from [C2] of concept category 325) standing or playing with a ball with a mountain background.

Similarly, text prompt 305 states “A [C5] dog and a [C2] cat (running/playing with a ball), [C4] castle background”. As described, [C5] refers to the images of first image element 315 (e.g., dog) obtained from concept category 325. Additionally, [C2] refers to the images of second image element 320 (e.g., cat) obtained from concept category 325. Additionally, [C4] refers to the images of background (e.g., castle) obtained from concept category 325. Accordingly, generated synthetic images 310 depict the first and second image elements (e.g., dog obtained from [C5] and cat obtained from [C2] of concept category 325) running or playing with a ball with a castle background.

FIG. 4 shows an example of an image processing apparatus 400 according to aspects of the present disclosure. Image processing apparatus 400 is an example of, or includes aspects of, the corresponding element described with reference to FIG. 1. In one aspect, image processing apparatus 400 includes processor unit 405, memory unit 410, I/O controller 415, training component 420, and machine learning model 425.

Processor unit 405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 405 is configured to operate a memory array using a memory controller. In other cases, a memory controller is integrated into processor unit 405. In some cases, processor unit 405 is configured to execute computer-readable instructions stored in memory unit 410 to perform various functions. In some aspects, processor unit 405 includes special purpose components for modem processing, baseband processing, digital signal processing, or transmission processing. According to some aspects, processor unit 405 comprises the one or more processors described with reference to FIG. 11.

Memory unit 410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 405 to perform various functions described herein.

In some cases, memory unit 410 includes a basic input/output system (BIOS) that controls basic hardware or software operations, such as an interaction with peripheral components or devices. In some cases, memory unit 410 includes a memory controller that operates memory cells of memory unit 410. For example, the memory controller may include a row decoder, column decoder, or both. In some cases, memory cells within memory unit 410 store information in the form of a logical state. According to some aspects, memory unit 410 comprises the memory subsystem described with reference to FIG. 11.

I/O controller 415 may manage input and output signals for a device. I/O controller 415 may also manage peripherals not integrated into a device. In some cases, an I/O controller 415 may represent a physical connection or port to an external peripheral. In some cases, an I/O controller 415 may utilize an operating system such as iOS®, ANDROID®, MS-DOS®, MS-WINDOWS®, OS/2®, UNIX®, LINUX®, or another known operating system. In other cases, an I/O controller 415 may represent or interact with a modem, a keyboard, a mouse, a touchscreen, or a similar device. In some cases, an I/O controller 415 may be implemented as part of a processor. In some cases, a user may interact with a device via I/O controller 415 or via hardware components controlled by an I/O controller 415.

In some examples, I/O controller 415 includes a user interface. A user interface may enable a user to interact with a device. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

According to some aspects, training component 420 is implemented as software stored in memory unit 410 and executable by processor unit 405, as firmware, as one or more hardware circuits, or as a combination thereof. According to some aspects, training component 420 is omitted from image processing apparatus 400. According to some aspects, training component 420 is implemented as software stored in memory and executable by a processor of an external apparatus, as firmware of the external apparatus, as one or more hardware circuits of the external apparatus, or as a combination thereof, and communicates with image processing apparatus 400 to perform the functions described herein.

According to some aspects, training component 420 trains, using the training set, the image generation model 430 to generate images including multiple custom elements from the set of custom elements by training each of a set of layers of the image generation model 430 to generate features representing a different custom element of the set of custom elements. In some examples, training component 420 updates parameters of the image generation model 430 based on the diffusion loss. In some aspects, the first layer is trained for generating images including the first image element and the second layer is trained separately from the first layer for generating images including the second image element.

Machine learning model 425 is an example of, or includes aspects of, the corresponding element described with reference to FIG. 5. According to some aspects, machine learning model 425 is implemented as software stored in memory unit 410 and executable by processor unit 405, as firmware, as one or more hardware circuits, or as a combination thereof. According to some aspects, machine learning model 425 comprises image generation model 430 stored in memory unit 410.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data. Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, that control a degree of connections between neurons and influence the neural network's ability to capture complex patterns in data. An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some aspects, machine learning model 425 obtains a training set including a set of images depicting a set of custom elements, respectively. In some examples, machine learning model 425 obtains pre-trained parameters for a layer of the image generation model 430. In some examples, machine learning model 425 fine-tunes the pre-trained parameters independently for each of the set of custom elements to obtain the set of layers. In some examples, machine learning model 425 computes a diffusion loss. In some examples, machine learning model 425 identifies a set of concept categories corresponding to the set of custom elements, respectively, where the image generation model 430 is trained to generate images including the multiple custom elements based on an input prompt including multiple concepts from the set of concept categories.

In one aspect, machine learning model 425 includes image generation model 430. According to some aspects, image generation model 430 generates, using a first layer of an image generation model 430, first image features representing the first image element. In some examples, image generation model 430 generates, using a second layer of the image generation model 430, second image features representing the second image element. In some examples, image generation model 430 generates, using the image generation model 430, a synthetic image including the first image element and the second image element based on the first image features and the second image features. In some examples, image generation model 430 selects the first layer and the second layer from a set of concept-specific layers based on the first image element and the second image element, respectively. In some examples, image generation model 430 combines the first image features and the second image features to obtain combined features representing the first image element and the second image element. In some aspects, the synthetic image includes customized variants of the first image element and the second image element based on the first image features and the second image features.

According to some aspects, image generation model 430 generates, first image features representing a first image element of an input prompt. In some examples, image generation model 430 generates, second image features representing a second image element of the input prompt. In some examples, image generation model 430 generates a synthetic image including the first image element and the second image element based on the first image features and the second image features. Image generation model 430 is an example of, or includes aspects of, the corresponding element described with reference to FIG. 5.

According to some aspects, image generation model 430 comprises parameters stored in the at least one memory component and trained to receive an input prompt including a first image element and a second image element and to generate a synthetic image including custom variants of the first image element and the second image element. In one aspect, image generation model 430 includes template generation model 435, mask generation model 440, inversion model 445, and diffusion model 450.

Template generation model 435 is an example of, or includes aspects of, the corresponding element described with reference to FIG. 5. According to some aspects, template generation model 435 is implemented as software stored in memory unit 410 and executable by processor unit 405, as firmware, as one or more hardware circuits, or as a combination thereof. According to some aspects, template generation model 435 is part of image generation model 430 stored in memory unit 410.

According to some aspects, template generation model 435 obtains a template image including a first template element corresponding to the first image element and a second template element corresponding to the second image element. In some examples, template generation model 435 obtains the template image includes generating the template image based on the input prompt.

According to some aspects, template generation model 435 is configured to generate a template image based on the input prompt, wherein the synthetic image is generated based on the template image. Template generation model 435 is an example of, or includes aspects of, the corresponding element described with reference to FIG. 5.

Mask generation model 440 is an example of, or includes aspects of, the corresponding element described with reference to FIG. 5. According to some aspects, mask generation model 440 is implemented as software stored in memory unit 410 and executable by processor unit 405, as firmware, as one or more hardware circuits, or as a combination thereof. According to some aspects, mask generation model 440 is part of image generation model 430 stored in memory unit 410.

According to some aspects, mask generation model 440 obtains a first mask indicating a region of the first image element and a second mask indicating a region of the second image element. In some examples, mask generation model 440 applies the first mask to the first image features and the second mask to the second image features to obtain first masked features and second masked features, respectively, where the synthetic image is generated based on the first masked features and the second masked features. In some examples, mask generation model 440 segments the template image to obtain the first mask and the second mask.

According to some aspects, mask generation model 440 is configured to generate a first mask indicating a region of the first image element and a second mask indicating a region of the second image element, wherein the synthetic image is generated based on the first mask and the second mask. Mask generation model 440 is an example of, or includes aspects of, the corresponding element described with reference to FIG. 5.

Inversion model 445 is an example of, or includes aspects of, the corresponding element described with reference to FIG. 5. According to some aspects, inversion model 445 is implemented as software stored in memory unit 410 and executable by processor unit 405, as firmware, as one or more hardware circuits, or as a combination thereof. According to some aspects, inversion model 445 is part of image generation model 430 stored in memory unit 410.

According to some aspects, inversion model 445 generates template features based on the template image, where the first image features and the second image features are based on the template features. According to some aspects, inversion model 445 is configured to generate template features based on the template image, wherein the first image features and the second image features are based on the template features.

Inversion model 445 is an example of, or includes aspects of, the corresponding element described with reference to FIGS. 5-7. In some aspects, the first image features and the second image features are generated in parallel and are located in a same feature space.

In some examples, inversion model 445 is a denoising diffusion implicit mode. (DDIM). DDIMs are a type of generative model used for producing high-quality synthetic data by iteratively denoising a latent variable. Unlike traditional diffusion models, DDIMs utilize a non-Markovian forward and reverse diffusion process, providing for faster convergence and improved sample quality. The process involves a parameterized noise schedule that ensures stability and efficiency. DDIMs leverage implicit modeling to generate samples directly from a simplified noise distribution, reducing computational requirements. The method is particularly effective in applications requiring high fidelity image synthesis, such as in AI-driven creative and data augmentation tasks.

Diffusion model 450 is an example of, or includes aspects of, the corresponding element described with reference to FIG. 5. According to some aspects, diffusion model 450 is implemented as software stored in memory unit 410 and executable by processor unit 405, as firmware, as one or more hardware circuits, or as a combination thereof. According to some aspects, diffusion model 450 is part of image generation model 430 stored in memory unit 410.

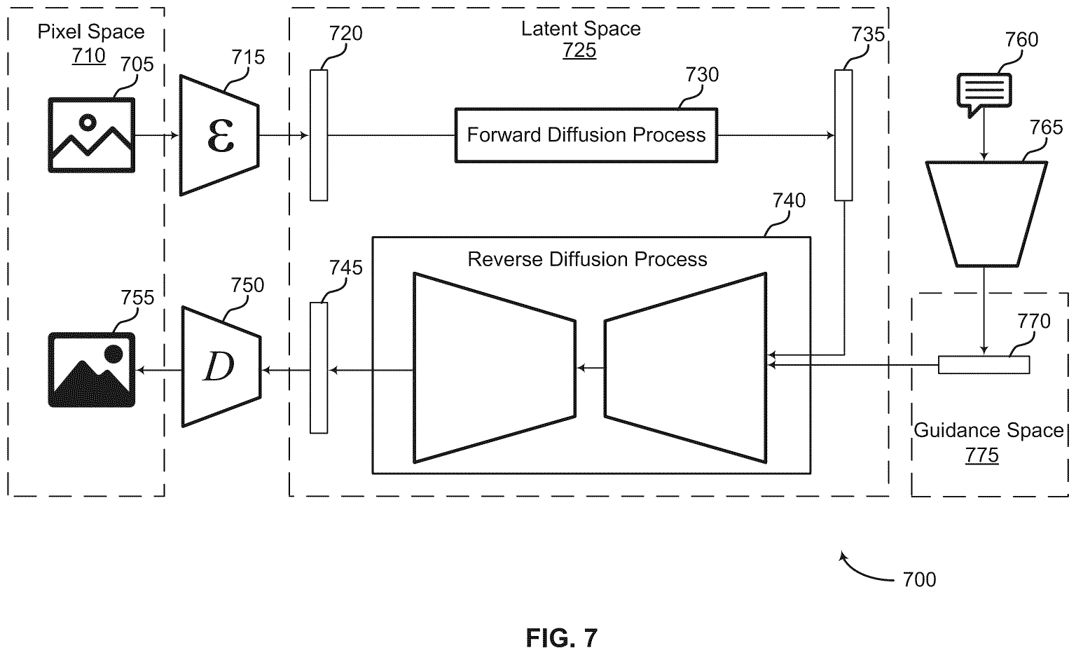

According to some aspects, diffusion model 450 trains key parameters and value parameters of a cross-attention layer 455 for each of the set of custom elements. In some aspects, the first layer and the second layer include parallel cross-attention layers 455 of a diffusion model 450. In one aspect, diffusion model 450 includes cross-attention layer 455. Diffusion model 450 is an example of, or includes aspects of, the corresponding element described with reference to FIG. 7. Cross-attention layer 455 is an example of, or includes aspects of, the corresponding element described with reference to FIG. 8.

In the machine learning field, an attention mechanism is a method of placing differing levels of importance on different elements of an input. Some sequence models process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

In some cases, an ANN employing an attention mechanism receives an input sequence and maintains its current state, which represents an understanding or context. For each element in the input sequence, the attention mechanism computes an attention score that indicates the importance or relevance of that element given the current state. The attention scores are transformed into attention weights through a normalization process (e.g., applying a softmax function). The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

In some cases, by incorporating an attention mechanism, an ANN dynamically allocates attention to different parts of the input sequence, allowing the ANN to focus on relevant information and capture dependencies across longer distances.

In some cases, calculating attention involves three basic steps. First, a similarity between a query vector Q and a key vector K obtained from the input is computed to generate attention weights. In some cases, similarity functions used for this process include dot product, splice, detector, and the like. Next, a softmax function is used to normalize the attention weights. Finally, the attention weights are weighed together with their corresponding values V. In the context of an attention network, the key K and value V are typically vectors or matrices that are used to represent the input data. The key K is used to determine which parts of the input the attention mechanism should focus on, while the value V is used to represent the actual data being processed.

In some cases, an attention mechanism may refer to a self-attention mechanism and/or a cross-attention mechanism. A self-attention mechanism enables a network to weigh input elements selectively (e.g., based on a relevance to other elements), emphasizing important features during computation. The self-attention mechanism incorporates dynamic attention scores, optimizing information processing. Additionally, a cross-attention mechanism facilitates effective interaction between different input sequences in neural network architectures by dynamically assigning attention scores based on their relevance. The cross-attention mechanism enhances model performance by providing for the network to focus on key features from one sequence while processing another, enabling more nuanced and context-aware information processing.

According to some aspects, cross-attention layer 455 performs the cross-attention mechanism includes computing a key vector and a value vector for each of the plurality of custom elements. In some aspects, the image generation model 430 includes a cross-attention layer 455 configured to perform a cross-attention mechanism between features of the elements in the template image and features representing the custom elements to obtain modified image features. In some aspects, the cross-attention layer 455 is configured to compute a key vector and a value vector for each of the custom elements. Cross-attention layer 455 is an example of, or includes aspects of, the corresponding element described with reference to FIG. 5.

Embodiments of the present disclosure are configured to be implemented in a customized text-to-image generation model. In some cases, the image is generated depicting a plurality of custom concepts. According to an embodiment, the image generation model generates a template image based on the received text prompt. In some cases, the text prompt describes an interaction of a plurality of elements (e.g., entities). For example, the template image aligns with the semantics of the received text prompt. In some cases, the template image is customized based on a plurality of customized variants of the elements described in the text prompt to generate a synthetic image.

FIG. 5 shows an example of an image generation model 500 according to aspects of the present disclosure. Image generation model 500 is an example of, or includes aspects of, the corresponding element described with reference to FIG. 4. In one aspect, image generation model 500 includes input prompt 505, template image 520, first mask 535, second mask 540, template generation model 545, mask generation model 550, inversion model 555, multi-concept generation model 565, and synthetic image 560.

According to an embodiment, an input prompt 505 is a text prompt. For example, referring to FIG. 5, the input prompt 505 states “A [C1] dog and a [C2] cat playing with a ball, [C3] mountain background”. As described with reference to FIG. 3, [C1], [C2], and [C3] denote custom concepts obtained from concept category (such as the bank of concepts corresponding to Step 1 in FIG. 5 or concept category 325 in FIG. 3). Input prompt 505 is an example of, or includes aspects of, the corresponding element described with reference to FIG. 3.

In one aspect, input prompt 505 includes first image element 510 and second image element 515. First image element 510 is an example of, or includes aspects of, the corresponding element described with reference to FIG. 3. Second image element 515 is an example of, or includes aspects of, the corresponding element described with reference to FIG. 3. As an example shown in FIG. 5, first image element 510 comprises a “dog” and second image element 515 comprises a “cat”.

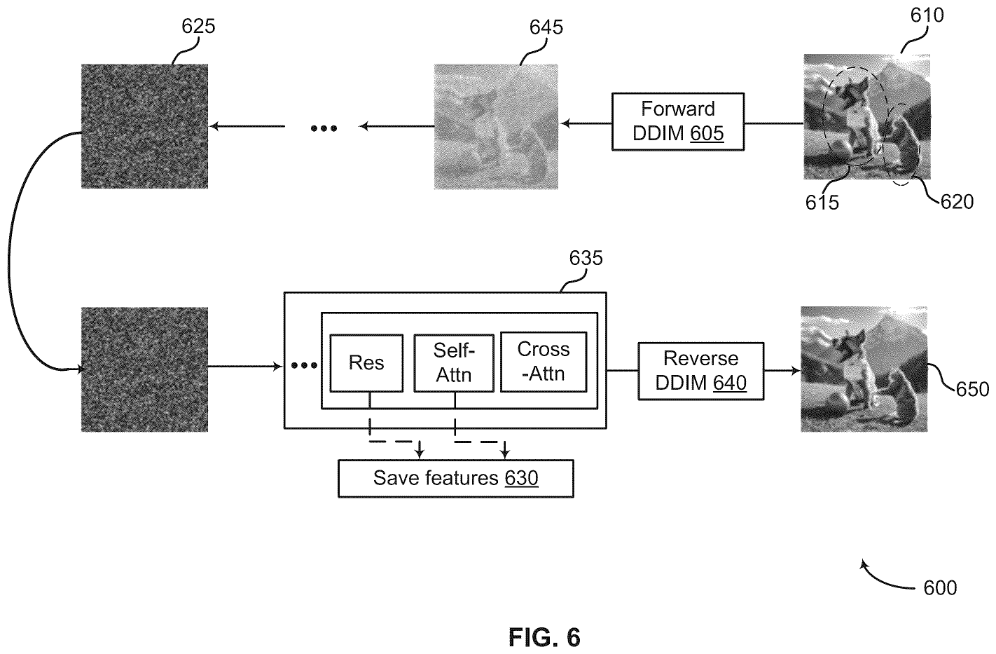

In some cases, template generation model 545 generates template image 520 based on a text-to-image model (e.g., corresponding to Step 2). For example, template generation model 545 is a Stable Diffusion model v.2.0 or higher. In some cases, template image 520 includes semantic objects (e.g., characters or elements) with a background specified in input prompt 505. Template generation model 545 is an example of, or includes aspects of, the corresponding element described with reference to FIG. 4. Template image 520 is an example of, or includes aspects of, the corresponding element described with reference to FIG. 6.

In one aspect, template image 520 includes first template element 525 and second template element 530. In some cases, each of first template element 525 and second template element 530 may be generalized elements. For example, referring to FIG. 5, first template element 525 and second template element 530 may depict a non-custom dog and a non-custom cat, respectively. First template element 525 is an example of, or includes aspects of, the corresponding element described with reference to FIG. 6. Second template element 530 is an example of, or includes aspects of, the corresponding element described with reference to FIG. 6.

In some cases, at Step 3, an inversion process is applied to template image 520 using inversion model 555. Inversion model 555 implements an inversion process on template image 520 to generate a latent representation to guide the image generation process. For example, as shown in FIG. 5, inversion model 555 generates noisy latent space z_{T} based on template image 520 using DDIM forward process. In some examples, inversion model 555 reconstructs template image 520 from inverted latent z_{T}. In some cases, a template feature is extracted from a layer of the diffusion model (such as a diffusion model described in FIG. 7). For example, the template feature is extracted at each timestep during the reverse reconstruction process. Inversion model 555 is an example of, or includes aspects of, the corresponding element described with reference to FIGS. 4 and 6-7. Further details regarding the inversion and template feature extraction process are provided with reference to FIGS. 6-7.

According to an embodiment, mask generation model 550 guides a structural information of the image generation process. In some cases, at Step 4, mask generation model 550 uses the inverted latent z_{T} and the template feature obtained during the inversion process to guide the structural information. In some cases, mask generation model 550 uses masked guidance to perform an element-wise editing of the template image (e.g., for concept-based editing of incorporating each target concept). In case of masked guidance, mask generation model 550 applies an image generation model (such as image generation model 430 described in FIG. 4 or a customized image generation model) to masked regions of template image 520.

In some cases, masked guidance is applied to regions corresponding to first template element 525 and second template element 530. In some examples, an image segmentation model (e.g., Text-SAM) is used to generate a semantic mask region. In some examples, mask generation model 550 incorporates a pre-trained text conditional grounding model to obtain bounding box regions corresponding to target concepts included in a received input prompt 505.

For example, mask generation model 550 obtains bounding box regions describing an element (e.g., single concept-wise words such as ‘a dog’, ‘a cat’, etc.). In some cases, mask generation model 550 extracts a mask for each element. For example, the mask generation model 550 extracts concept-wise masks M₁, M₂, . . . M_{N} for N different concepts. In some cases, mask generation model 550 sets an unmasked region in template image 520 as background mask M_{bg}=(M₁∪M₂∪ . . . M_{N})^{c}. In some cases, mask generation model 550 generates a dilated mask. For example, in case of a dilated mask, a masked region is expanded from the original area. First mask 535 and second mask 540 are examples of, or include aspects of, the corresponding element described with reference to FIG. 8. Mask generation model 550 is an example of, or includes aspects of, the corresponding element described with reference to FIG. 4.

In some cases, synthetic image 560 is generated using features from each of the cross-attention, self-attention, and residual layers of the diffusion model (such as the diffusion model described with reference to FIGS. 6-8). In some cases, pre-calculated features (template features) obtained during the reverse reconstruction process (e.g., as described with reference to inversion model 555 and further described in FIG. 6) are injected to the U-Net model. In some cases, a multi-concept generation model 565 is used comprising a concept-aware text conditioning strategy, wherein the text condition input contains a sentence which only includes one element. Additionally, multi-concept generation model 565 combines the elements in the feature space of cross-attention layers to generate mixed features.

In some cases, synthetic image 560 is generated based on the mixed features. Accordingly, synthetic image 560 depicts a desired dog and a desired cat (e.g., obtained from the bank of concepts in Step 1) playing with a ball, mountain background. Synthetic image 560 is an example of, or includes aspects of, the corresponding element described with reference to FIGS. 3 and 8. Further details regarding the generation of the mixed features are provided with reference to FIG. 8.

FIG. 6 shows an example of an image inversion process 600 according to aspects of the present disclosure. In one aspect, image inversion process 600 includes forward DDIM model 605, template image 610, intermediate latent 645, noisy image 625, U-Net model 635, template features 630, reverse DDIM model 640, and reconstructed image 650.

Forward DDIM 605 is applied to template image 610 to obtain a latent representation. In some cases, the latent representation obtained is used to guide the image generation process. Template image 610 is an example of, or includes aspects of, the corresponding element described with reference to FIG. 5. In one aspect, template image 610 includes first template element 615 and second template element 620. First template element 615 and second template element 620 are examples of, or include aspects of, the corresponding element described with reference to FIG. 5. Forward DDIM 605 is an example of, or includes aspects of, the corresponding element described with reference to FIGS. 4, 5, and 7.

Referring to FIG. 6, forward DDIM model 605 generates intermediate latent 645 (zₜ) at a timestep t from template image 610. In some cases, forward DDIM model 605 generates noisy latent 625 (Z_{T}) from template image 610 (e.g., source image x_{src}). Noisy image 625 is an example of, or includes aspects of, the corresponding element described with reference to FIG. 8.

Reverse DDIM model 640 implements a reverse DDIM process to accurately reconstruct the source image (e.g., reconstructed image 650) from the noisy latent 625 (e.g., from inverted latent z_{T}). In some cases, U-Net model extracts template features

$$630 ( i . e . , {f}_{t}^{l} )$$

from the l-th layer of the U-Net model during the reverse reconstruction process. In some cases, template features

$$630 ( i . e . , {f}_{t}^{l} )$$

are extracted at each timestep t. The template features 630 include intermediate outputs from residual layers and self-attention activations. According to an exemplary embodiment, a template feature is extracted from a ResNet output at l=4 and self-attention maps at l=4, 7,9. In some examples, a reference text condition p_{src} is used during the inversion process. Further details regarding the inversion process are provided with reference to FIG. 7. Template features 630 is an example of, or includes aspects of, the corresponding element described with reference to FIG. 8.

FIG. 7 shows an example of a latent diffusion architecture 700 according to aspects of the present disclosure. Diffusion models are a class of generative ANNs that can be trained to generate new data with features similar to features found in training data. In particular, diffusion models can be used to generate novel images. Diffusion models can be used for various image generation tasks, including image super-resolution, generation of images with perceptual metrics, conditional generation (e.g., generation based on text guidance), image inpainting, and image manipulation.

Diffusion models function by iteratively adding noise to data during a forward diffusion process and then learning to recover the data by denoising the data during a reverse diffusion process. Examples of diffusion models include Denoising Diffusion Probabilistic Models (DDPMs) and Denoising Diffusion Implicit Models (DDIMs). In DDPMs, a generative process includes reversing a stochastic Markov diffusion process. On the other hand, DDIMs use a deterministic process so that a same input results in a same output. Diffusion models may also be characterized by whether noise is added to an image itself, or to image features generated by an encoder, as in latent diffusion.

For example, according to some aspects, image encoder 715 encodes original image 705 from pixel space 710 and generates original image features 720 in latent space 725. In some cases, original image 705 is an example of, or includes aspects of, a training image described with reference to FIG. 10. In some cases, image encoder 715 covers an image structure and semantic concepts of original image 705.

According to some aspects, forward diffusion process 730 gradually adds noise to original image features 720 to obtain noisy features 735 (also in latent space 725) at various noise levels. In some cases, forward diffusion process 730 is implemented by an image processing apparatus (such as the image processing apparatus described with reference to FIGS. 4-5) or by a training component (such as the training component described with reference to FIG. 4).

According to some aspects, reverse diffusion process 740 is applied to noisy features 735 to gradually remove the noise from noisy features 735 at the various noise levels to obtain denoised image features 745 in latent space 725. In some cases, reverse diffusion process 740 is implemented as the reverse diffusion process described with reference to FIG. 5. In some cases, reverse diffusion process 740 is implemented using a U-Net ANN included in the image generation model.

According to some aspects, a training component (such as the training component described with reference to FIG. 4) compares denoised image features 745 to original image features 720 at each of the various noise levels, and updates parameters of the image generation model or the additional image generation model based on the comparison. In some cases, image decoder 750 decodes denoised image features 745 to obtain output image 755 in pixel space 710. In some cases, an output image 755 is created at each of the various noise levels. In some cases, the training component compares output image 755 to original image 705 to train the diffusion model.

In some cases, image encoder 715 and image decoder 750 are pretrained prior to training the image generation model. In some examples, image encoder 715, image decoder 750, and the image generation model are jointly trained. In some cases, image encoder 715 and image decoder 750 are jointly fine-tuned with the image generation model.

According to some aspects, reverse diffusion process 740 is guided based on a guidance prompt such as one or more prompts 760 (e.g., a text prompt, a skeleton map or a combination thereof). In some cases, prompt 760 is encoded using encoder 765 to obtain guidance features 770 in guidance space 775. In some cases, guidance features 770 are combined with noisy features 735 at one or more layers of reverse diffusion process 740 to encourage output image 755 to include content described by prompt 760. For example, guidance features 770 can be combined with noisy features 735 using a cross-attention block within reverse diffusion process 740.

Cross-attention, also known as multi-head attention, is an extension of the attention mechanism used in some ANNs for NLP tasks. In some cases, cross-attention enables reverse diffusion process 740 to attend to multiple parts of an input sequence simultaneously, capturing interactions and dependencies between different elements. In cross-attention, there are typically two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing reverse diffusion process 740 to better understand the context and generate more accurate and contextually relevant outputs.

According to some aspects, image encoder 715 and image decoder 750 are omitted, and forward diffusion process 730 and reverse diffusion process 740 occur in pixel space 710. For example, in some cases, forward diffusion process 730 adds noise to original image 705 to obtain noisy images in pixel space 710, and reverse diffusion process 740 gradually removes noise from the noisy images to obtain output image 755 in pixel space 710.

In some examples, diffusion models are based on a neural network architecture known as a U-Net. The U-Net takes input features having an initial resolution and an initial number of channels, and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt describing content to be included in a generated image. For example, a user may provide the prompt “a person playing with a cat”. In some examples, guidance can be provided in a form other than text, such as via an image, a sketch, or a layout. The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the system generates an image based on the noise map and the conditional guidance vector.

A diffusion process can include both a forward diffusion process for adding noise to an image (or features in a latent space) and a reverse diffusion process for denoising the images (or features) to obtain a denoised image. The forward diffusion process can be represented as q(xₜ+xₜ₋₁), and the reverse diffusion process can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data XT, such as a noisy image and denoises the data to obtain the p(xₜ₋₁|xₜ). At each step t−1, the reverse diffusion process takes xₜ, such as first intermediate image, and t as input. Here, t represents a step in the sequence of transitions associated with different noise levels, The reverse diffusion process outputs xₜ₋₁, such as second intermediate image iteratively until x_{T} is reverted back to x₀, the original image. The reverse process can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) \qquad ( 1 )$$

The joint probability of a sequence of samples in the Markov chain can be written as a product of conditionals and the marginal probability:

$${x}_{T} : {P}_{θ} ( {x}_{0 : T} ) := p ( {x}_{T} ) {Π}_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse process takes the outcome of the forward process, a sample of pure noise, as input and

$${Π}_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and x represents the generated image with high image quality.

A diffusion model may be trained using both a forward and a reverse diffusion process. In one example, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

The system then adds noise to a training image using a forward diffusion process in N stages. In some cases, the forward diffusion process is a fixed process where Gaussian noise is successively added to an image. In latent diffusion models, the Gaussian noise may be successively added to features in a latent space.

At each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

The training system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data. The training system then updates parameters of the model based on the comparison. For example, parameters of a U-Net may be updated using gradient descent. Time-dependent parameters of the Gaussian transitions can also be learned.

FIG. 8 shows an example of a combination process 800 according to aspects of the present disclosure. In one aspect, combination process 800 includes noisy image 805, first layer 810, second layer 820, template features 830, first mask 835, second mask 840, and synthetic image 845.

An embodiment of the present disclosure is configured to generate a synthetic image with multiple customized elements. In some cases, the images are generated with multi-concept characters or elements. In some cases, a unified sampling process is used to combine the multiple models including an element. For example, an embodiment of the present disclosure is configured to implement a sampling process that combines the multiple single-concept personalized models.

Referring to FIGS. 6 and 8, a diffusion model is used to denoise the noise component from an inverted noisy latent z_{T} or noisy image 805. Noisy image 805 is an example of, or includes aspects of, the corresponding element described with reference to FIG. 6. In some cases, a concept category including a bank of concepts (such as concept category 325 or a bank of concepts described with reference to FIG. 3) comprises parameter sets for fine-tuned single-concept models. In some cases, combination process 800 includes selecting N concepts for generation, of which the weight parameters are θ₁, θ₂, . . . θ_{N}. In some cases, combination process 800 includes selecting a concept (e.g., one concept) for background generation, with parameters of θ_{bg}.

In some cases, multiple score estimation outputs are combined as:

$${ϵ}_{f u s e} = {\sum }_{i}^{N} {ϵ}_{{θ}_{i}} ( {z}_{t} , t , {p}_{+ i} ) {M}_{i} + {ϵ}_{{θ}_{b g}} ( {z}_{t} , t , {p}_{+ b g} ) {M}_{b g} \qquad ( 3 )$$

where ϵ_{θ}ᵢ(zₜ, t, p₊ᵢ) is the model output from the ith concept. Mᵢ is the corresponding mask region for each concept. In some cases, such combination of the different models in score estimation may generate undesired output images.

According to an embodiment, pre-calculated template features

$${f}_{t}^{l}$$

(such as template features 630 as described with reference to FIG. 6) are injected to the U-Net model. In some cases, concept-aware parameters correspond to (e.g., are related to) cross-attention layers (e.g., concept-aware parameters are different from saved template features

$${f}_{t}^{l}$$

since template features

$${f}_{t}^{l}$$

are extracted from residual and self-attention layers). Therefore, a unified structural information to the entire sampling steps is obtained without deteriorating the representation of custom concepts.

An embodiment of the present disclosure provides a concept-aware text conditioning strategy. In some examples, the text conditioning refers to a text condition input p₊ᵢ that contains a sentence which includes an element or a single concept-indication modifier word. For example, in case concepts of [c1] dog, [c2] cat, and [bg] mountain background are combined, the prompt construction strategy starts with a basic text prompt:

p_{base}=“A dog and a cat playing with a ball, mountain background”

In some cases, a placeholder token is placed adjacent to (e.g., in front of or before) each concept (or element) for each text condition such as:

p₊₁=“A [c1] dog playing with a ball, mountain background”

p₊₂=“A [c2] cat playing with a ball, mountain background”

p_{+bg}=“A dog and a cat playing with a ball, [bg] mountain background”

Based on differently constructed text conditions, embodiments of the present disclosure are able to sample the concept-specific image in the targeted regions.

In some cases, each of the different elements (e.g., concepts) are combined in the feature space of a cross-attention layer (e.g., cross-attention layer 815 and cross-attention layer 825). As an example shown in FIG. 8, cross-attention layer 815 and cross-attention layer 825 correspond to different elements or concepts. In one aspect, first layer 810 corresponding to Concept 1 (e.g., dog) includes cross-attention layer 815. Cross-attention layer 815 is an example of, or includes aspects of, the corresponding element described with reference to FIG. 4. In one aspect, second layer 820 corresponding to Concept 2 (e.g., cat) includes cross-attention layer 825. Cross-attention layer 825 is an example of, or includes aspects of, the corresponding element described with reference to FIG. 4.

According to an embodiment, first layer 810 and second layer 820 extract an output feature

$${h}_{i}^{l , t}$$

from the Ith cross-attention layers and timestep t. Template features 830 is an example of, or includes aspects of, the corresponding element described with reference to FIG. 6. In some cases, first layer 810 and second layer 820 extract the output feature with the ith concept weight parameter θᵢ and concept-aware prompt p₊ᵢ. In some cases, l, t are removed since the feature is used in each layer and timestep.

Based on the extracted features for each concept, mixed features are computed as:

$${h}_{f u s e} = {\sum }_{i}^{N} {h}_{i} {M}_{i} + {h}_{b g} {M}_{b g} \qquad ( 4 )$$

where Mᵢ represents the mask for the ith concept and M_{bg} represents the mask for background. First mask 835 is an example of, or includes aspects of, the corresponding element described with reference to FIG. 5. Second mask 840 is an example of, or includes aspects of, the corresponding element described with reference to FIG. 5. Each of the first and second masks (i.e., 835 and 840) represent a mask for the first and second concepts. For example, as shown in FIG. 8, first mask 835 depicts a mask for the first image element, i.e., a dog, and second mask 840 depicts a mask for the second image element, i.e., a cat.

An embodiment of the present disclosure includes a concept-free suppression method to remove the concept-free features during sampling process. In some cases, the cross attention features h_{base} are computed from a concept-free (e.g., not fine-tuned) model ϵ_{θ}_{_{base}} with a basic text condition p_{base}. In some cases, the concept-free features are extrapolated with the initial fused features as:

$${h}_{f u s e} = ( 1 + λ ) [ {\sum }_{i}^{N} {h}_{i} {M}_{i} + {h}_{b g} {M}_{b g} ] - λ {h}_{b a s e}^{l , t} \qquad ( 5 )$$

Next, the fused score estimation is given as:

$${ϵ}_{f u s e} = {ϵ}_{θ} ( {z}_{t} , t ; {h}_{f u s e} ; {f}_{t} ) \qquad ( 6 )$$

where h_{fuse} represents the fused features in cross attention layers, and fₜ represents the pre-calculated features in self-attention and residual layers. In some cases, the image generation model includes pre-calculated features fₜ that influence the structural aspects of the image. In some cases, the fused features h_{fuse} correspond to concept-wise semantic information. In some cases, synthetic image 845 is generated based on the fused features h_{fuse}. Synthetic image 845 is an example of, or includes aspects of, the corresponding element described with reference to FIGS. 3 and 5.

In some cases, a classifier-free guidance is performed to extrapolate the output from unconditional text condition p_{Ø}=Ø. In some cases, a negative prompt strategy is used (e.g., instead of an unconditional text condition) to ensure that the output image (e.g., synthetic image 845) excludes unwanted attributes described in the negative prompt p_{neg}. The negative-guidance score output is represented as:

$$ϵ = ω \cdot {ϵ}_{f u s e} + ( 1 - ω ) \cdot {ϵ}_{{θ}_{b a s e}} ( {z}_{t} , t , {p}_{n e g} ; {f}_{t} ) \qquad ( 7 )$$

Accordingly, by separate implementation of the pre-calculated features and the fused features, embodiments of the present disclosure are able to maintain the overall structure of the template image and simultaneously alter the semantics of the template elements (i.e., objects in the template image) to align with custom elements (or custom concepts). Therefore, the distinction in the aspects of the pre-calculated features and the fused features provides for precise manipulation of images according to specific requirements.

Thus, one or more aspects of the system and apparatus include at least one processor; at least one memory component coupled with the at least one processor; and an image generation model comprising parameters stored in the at least one memory component and trained to generate, using a first layer of the image generation model, first image features representing a first image element of an input prompt; generate, using a second layer of the image generation model, second image features representing a second image element of the input prompt, and generate a synthetic image including the first image element and the second image element based on the first image features and the second image features.

Some examples of the apparatus and system further include a template generation model configured to generate a template image based on the input prompt, wherein the synthetic image is generated based on the template image.

Some examples of the apparatus and system further include a mask generation model configured to generate a first mask indicating a region of the first image element and a second mask indicating a region of the second image element, wherein the synthetic image is generated based on the first mask and the second mask.

Some examples of the apparatus and system further include an inversion model configured to generate template features based on the template image, wherein the first image features and the second image features are based on the template features. In some aspects, the first layer and the second layer comprise parallel cross-attention layers of a diffusion model.

### Image Generation Process

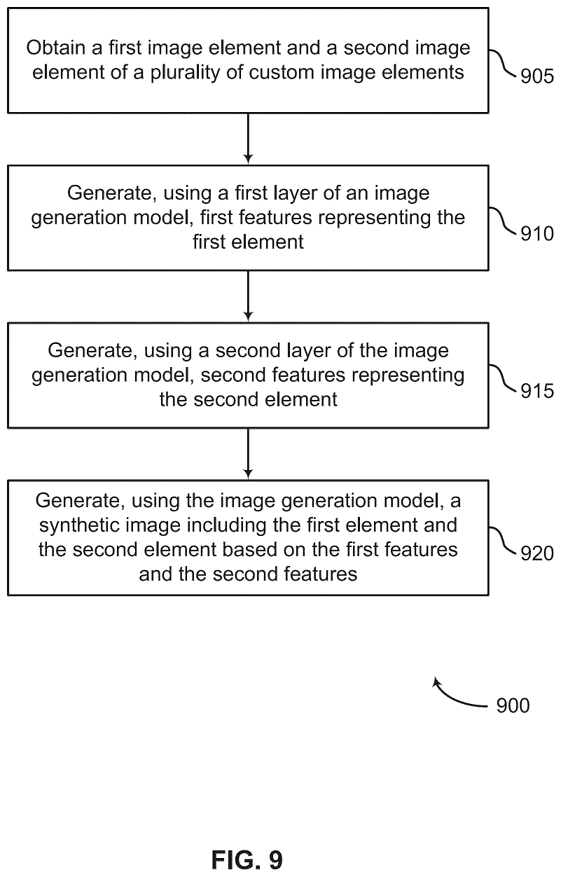

A method for image generation is described with reference to FIG. 9. Embodiments of the method include generating an image that includes multiple custom image elements. Embodiments include the custom elements in a scene described by an input prompt. In some cases, the output image depicts interactions between the custom elements. Features for each of the custom objects are generated by specially trained layers that are dynamically selected based on the objects.

In some cases, the model generates a template image including generalized concepts based on a text prompt. The image generation model then masks regions of the image for insertion or removal of custom concepts. The model fuses a target or custom concept with the template image while leveraging regional guidance. The model includes an attention module that enables preservation of semantics of the template image (i.e., details such as background, postures, etc.) of the input image while replacing the generalized concept with a custom concept.

FIG. 9 shows an example of a method 900 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Embodiments of the present disclosure include a method for enabling multi-concept fusion in text-to-image models. According to an embodiment, the image processing apparatus (such as the image processing apparatus described with reference to FIG. 4) obtains an input prompt that includes a plurality of objects or elements. In some cases, the input prompt is a text prompt. In some examples, the input prompt states that “a dog and a cat are playing with a ball, mountain background” (as described with reference to FIGS. 2-3 and 5-8).

In some cases, the image processing apparatus comprises an image generation model. In some cases, the image generation model includes template generation model (such as template generation model 435 described with reference to FIG. 4) that generates a template image that semantically depicts the input prompt. For example, the image processing apparatus, uses a diffusion model to generate a template image that depicts “a dog and a cat playing with a ball, mountain background”. In some cases, the “dog” and “cat” in the template image are generalized versions of the said elements. Additionally, the image processing apparatus obtains a custom image of the objects or elements described in the input prompt. For example, the image processing apparatus obtains a custom image of a dog and a custom image of a cat that the user desires.

The image generation model includes inversion model (such as the inversion model 445 described with reference to FIG. 4) that implements an inversion process on the obtained template image along with feature extraction to save the structural information. In some cases, the image generation model includes mask generation model (such as mask generation model 440 described with reference to FIG. 4) that extracts mask regions from the template image.

In some cases, the image generation model includes a diffusion model with cross-attention layers (such as diffusion model 450 with cross-attention layer 455 described with reference to FIG. 4) for implementing a combination process (such as process 800 described with reference to FIG. 8). In some cases, the features extracted from the template image during the inversion process are injected into the layers (i.e., self-attention layer and residual layer) of the diffusion model. For example, different features from each mask region of the template image are combined after obtaining multiple cross-attention layer features. In some cases, an output (i.e., synthetic) image is generated based on the combined features.

At operation 905, the system obtains a first image element and a second image element. In some cases, the system obtains an input prompt describing a scene including the first image element and the second image element. In some cases, the operations of this step refer to, or may be performed by, an image processing apparatus as described with reference to FIGS. 1 and 4. In some cases, the image processing apparatus obtains the first image element and the second image element, that is different from the first image element, of a plurality of custom image elements.

For example, in some cases, the image processing apparatus receives an input prompt from a user (such as the user described with reference for FIG. 1) or by retrieval from a database (such as the database described with reference to FIG. 1) or other data source. In some cases, the input prompt includes a plurality of elements (e.g., objects). Additionally, in some cases, the image processing apparatus receives a custom image from the user or database or any other data source.

At operation 910, the system generates, using a first layer of an image generation model, first image features representing the first image element. In some cases, the operations of this step refer to, or may be performed by, an image generation model as described with reference to FIGS. 4 and 5.

At operation 915, the system generates, using a second layer of the image generation model, second image features representing the second image element. In some cases, the operations of this step refer to, or may be performed by, an image generation model as described with reference to FIGS. 4 and 5.

In some cases, the image generation model generates a template image and applies an inversion process on the template image with simultaneous feature extraction to save the structural information of the template image. In some cases, mask generation model extracts mask regions of the template image. In some cases, the image generation model generates combined image features based on combining the different custom elements in the feature space of different cross-attention layers. In some cases, the cross-attention mechanism provides for guidance of combination of features extracted from the template image and the custom elements. Further details regarding the cross-attention mechanism and generation of combined features have been provided with reference to FIGS. 5 and 8.

At operation 920, the system generates, using the image generation model, a synthetic image including the first image element and the second image element based on the first image features and the second image features. In some cases, the operations of this step refer to, or may be performed by, an image generation model as described with reference to FIGS. 4 and 5.

In some cases, the image generation model generates the synthetic image based on the combined image features. For example, the image generation model generates the image via a reverse diffusion process using the combined image features as described with reference to FIGS. 5-8. In some cases, the features from the template image are combined with custom images using a cross-attention block within reverse diffusion process to condition the reverse diffusion process. In some cases, the synthetic image is generated using multiple iterations of the image generation model (e.g., multiple forward passes of a reverse diffusion process described with reference to FIGS. 5 and 7-8). In some cases, the image processing apparatus provides the synthetic image, a high-resolution image to the user via the user interface.

Accordingly, one or more aspects of the method include obtaining an input prompt including a first image element and a second image element; generating, using a first layer of an image generation model, first image features representing the first image element; generating, using a second layer of the image generation model, second image features representing the second image element; and generating, using the image generation model, a synthetic image including the first image element and the second image element based on the first image features and the second image features.

Some examples of the method, apparatus, and non-transitory computer readable medium further include obtaining a first mask indicating a region of the first image element and a second mask indicating a region of the second image element. Some examples further include applying the first mask to the first image features and the second mask to the second image features to obtain first masked features and second masked features, respectively, wherein the synthetic image is generated based on the first masked features and the second masked features.

Some examples of the method, apparatus, and non-transitory computer readable medium further include obtaining a template image including a first template element corresponding to the first image element and a second template element corresponding to the second image element. Some examples further include segmenting the template image to obtain the first mask and the second mask.

Some examples of the method, apparatus, and non-transitory computer readable medium further include generating template features based on the template image, wherein the first image features and the second image features are based on the template features. Some examples of the method, apparatus, and non-transitory computer readable medium further include obtaining the template image comprises: generating the template image based on the input prompt.

Some examples of the method, apparatus, and non-transitory computer readable medium further include selecting the first layer and the second layer from a plurality of concept-specific layers based on the first image element and the second image element, respectively.

Some examples of the method, apparatus, and non-transitory computer readable medium further include combining the first image features and the second image features to obtain combined features representing the first image element and the second image element. In some aspects, the first image features and the second image features are generated in parallel and are located in a same feature space.

In some aspects, the synthetic image includes customized variants of the first image element and the second image element based on the first image features and the second image features. In some aspects, the first layer is trained for generating images including the first image element and the second layer is trained separately from the first layer for generating images including the second image element.

### Training

A method for image generation is described with reference to FIGS. 10-11. FIG. 10 shows an example of a method 1000 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Embodiments of the present disclosure include a method for enabling multi-concept fusion in text-to-image models. According to an embodiment, the image processing apparatus is configured to train the image generation model to generate synthetic images in a real-world application of the multi-concept fusion process (described in FIG. 8). In some cases, the generated synthetic images consider the interaction of the elements described in the text while providing custom variants of the elements. For example, the synthetic images incorporate custom elements provided by the user into a generalized image generated based on a received text prompt.

Referring to FIG. 10, an image processing apparatus (such as the image processing apparatus described with reference to FIG. 4) trains an image generation model (such as the image generation model described with reference to FIGS. 5-8) to generate images based on training the layers corresponding to each of the custom elements, where the training image comprises features representing different custom elements. Conventional image generation models are not able to produce images that can consistently perform multi-concept fusion for a plurality of concepts. For example, conventional image generation models tend to generate images that have blended concepts. In some examples, conventional image generation models generate images with missing concepts.

Accordingly, the image generation model of an embodiment of the present disclosure is capable of generating an image with a desired concept (e.g., a plurality of concepts). For example, the image generation model is configured to perform training of the plurality of layers corresponding to each of the custom concepts. In some examples, each of the trained layers are configured to generate features that represent a different custom element of the plurality of custom elements.

At operation 1005, the system obtains a training set including a first image depicting a first image element and a second image depicting a second image element. In some cases, the system obtains a training set including a set of images depicting a set of custom elements, respectively. In some cases, the operations of this step refer to, or may be performed by, a machine learning model as described with reference to FIG. 4.

For example, in some cases, the machine learning model obtains a training set that includes images depicting a plurality of custom elements from a database (such as the database described with reference to FIG. 1), from another data source (such as the Internet), or from a user. In some cases, the training image depicts a custom element. In some cases, the training image depicts a plurality of custom elements.

At operation 1010, the system trains, using the training set, the image generation model to generate a synthetic image including the first image element and the second image element. In some cases, the training of the image generation model comprises training a first layer of the image generation model to generate features representing the first image element using the first image in a first training phase and training a second layer of the image generation model to generate features representing the second image element using the second image in a second training phase.

In some cases, the system trains, using the training set, the image generation model to generate images including multiple custom elements from the set of custom elements by training each of a set of layers of the image generation model to generate features representing a different custom element of the set of custom elements. In some cases, the operations of this step refer to, or may be performed by, a training component as described with reference to FIG. 4.

An embodiment of the present disclosure includes fine-tuning a pretrained text-to-image model to embed each of the target concepts in the custom category (e.g., bank of concepts). For example, a custom diffusion model is used as the model does not change any residual or self-attention layers. In some cases, the custom diffusion model fine-tunes the cross-attention layers of the U-Net model ϵ_{θ}. In some cases, with the text condition p∈R^{s×d} and self-attention feature f∈R^{(h×w)×c}, the cross attention layer consists of Q=W^{q}f, K=W^{k}p, V=W^{v}p.

An embodiment of the present disclosure includes fine-tuning the key and value weight parameters W^{k}, W^{v} of the cross-attention layers. In some cases, modifier tokens [V*] are used which are placed ahead of the concept word (e.g., [V*] dog) and operate as a constraint to general concepts. In some cases, the fine-tuning process is augmented with a robust data augmentation technique. In some cases, an arbitrary personalization approach is incorporated in case the method is related to cross-attention layers.

According to some aspects, the image generation model generates an image with a desired custom element (e.g., a plurality of custom elements). According to some aspects, the image generation model generates an image based on the training image (for example, using a cross-attention mechanism and a reverse diffusion process as described with reference to FIGS. 5-8). In some cases, the training component determines a loss according to a loss function based on a comparison of the ground-truth image and the training image.

A loss function refers to a function that impacts how a machine learning model is trained based on a supervised learning model. For example, during each training iteration, the output of the machine learning model is compared to the known annotation information in the training data. The loss function provides a value (the “loss”) for how close the predicted annotation data is to the actual annotation data. After computing the loss, the parameters of the model are updated accordingly and a new set of predictions are made during the next iteration.

Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). In some cases, a supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples. In some cases, the training component updates image generation parameters of the image generation model based on the loss. In some cases, the training component trains the image generation model as described herein.

According to an embodiment, the training component trains the image generation model to perform multi-concept fusion based on masking portions of elements in an input image. In some cases, the image is masked to combine the custom elements with the image generated based on the text prompt. According to an embodiment, the training component trains the image generation model to identify different elements using bounding boxes. According to an example, the trained layers are used to specify the custom elements in the generated output image (e.g., synthetic image).

FIG. 11 shows an example of a method of training a diffusion model 1100 according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 11, according to some aspects, a training component (such as the training component described with reference to FIG. 4) trains a diffusion model (such as the image generation model described with reference to FIGS. 6-7) to generate an image.

At operation 1105, the system initializes the diffusion model. In some cases, the operations of this step refer to, or may be performed by, a training component as described with reference to FIG. 4. In some cases, the initialization includes defining the architecture of the diffusion model and establishing initial values for parameters of the diffusion model. In some cases, the training component initializes the diffusion model to implement a U-Net architecture. In some cases, the initialization includes defining hyperparameters of the architecture of the diffusion model, such as a number of layers, a resolution and channels of each layer block, a location of skip connections, and the like.

At operation 1110, the system adds noise to a training image (or an additional training image) using a forward diffusion process (such as the forward diffusion process described with reference to FIG. 7) in N stages. In some cases, the operations of this step refer to, or may be performed by, a training component as described with reference to FIG. 4.

At operation 1115, at each stage n, starting with stage N, the system predicts an image for stage n−1 using a reverse diffusion process (such as a reverse diffusion process described with reference to FIG. 7). In some cases, the operations of this step refer to, or may be performed by, the diffusion model. In some cases, each stage n corresponds to a diffusion step t. In some cases, at each stage n, the diffusion model predicts noise that can be removed from an intermediate image to obtain a predicted image. In some cases, an original image is predicted at each stage of the training process.

In some cases, the reverse diffusion process is conditioned on a training prompt or other guidance (such as saved features as described with reference to FIGS. 6 and 8). In some cases, an encoder obtains the training prompt and generates guidance features in a guidance space. In some cases, at each stage, the diffusion model predicts noise that can be removed from an intermediate image to obtain a predicted image that aligns with the guidance features.

At operation 1120, the system compares the predicted image at stage n−1 to an actual image, such as the image at stage n−1 or the original input image. In some cases, the operations of this step refer to, or may be performed by, a training component as described with reference to FIG. 4. In some cases, the training component computes a loss function based on the comparison.

At operation 1125, the system updates parameters of the diffusion model based on the comparison. In some cases, the operations of this step refer to, or may be performed by, a training component as described with reference to FIG. 4. In some cases, the training component updates the machine learning parameters of the diffusion model based on the loss function. For example, in some cases, the training component updates parameters of the U-Net using gradient descent. In some cases, the training component trains the U-Net to learn time-dependent parameters of the Gaussian transitions. In some cases, the training component optimizes for a negative log likelihood.

Accordingly, one or more aspects of the method include obtaining a training set including a plurality of images depicting a plurality of custom elements, respectively and training, using the training set, the image generation model to generate images including multiple custom elements from the plurality of custom elements by training each of a plurality of layers of the image generation model to generate features representing a different custom element of the plurality of custom elements.

Some examples of the method, apparatus, and non-transitory computer readable medium further include obtaining pre-trained parameters for a layer of the image generation model. Some examples further include fine-tuning the pre-trained parameters independently for each of the plurality of custom elements to obtain the plurality of layers.

Some examples of the method, apparatus, and non-transitory computer readable medium further include training key parameters and value parameters of a cross-attention layer for each of the plurality of custom elements.

Some examples of the method, apparatus, and non-transitory computer readable medium further include computing a diffusion loss. Some examples further include updating parameters of the image generation model based on the diffusion loss.

Some examples of the method, apparatus, and non-transitory computer readable medium further include identifying a plurality of concept categories corresponding to the plurality of custom elements, respectively, wherein the image generation model is trained to generate images including the multiple custom elements based on an input prompt including multiple concepts from the plurality of concept categories.

### Implementation and Evaluation

According to an exemplary embodiment, for a step 1 (referring to FIG. 5) single concept personalization, a repository of a custom diffusion model is used. In some cases, a pre-trained Stable Diffusion V2.1 (SD2.1) is used for fine-tuning. In some cases, a SD 2.1 is used for a baseline method. For each concept, the models are fine-tuned with 500 steps using learning rate of 1e-5. For step 2, i.e., template image generation in FIG. 5, images generated from Stable Diffusion XL with 50 sampling steps are used. In some examples, a higher resolution of images (e.g., 1024×1024) are generated which takes 10 seconds for generating the image. In some cases, the source image for step 2 is a real images which contains the multiple objects. For example, in step 4 in FIG. 5, i.e., mask generation, the pipelines from langSAM are used. In case of steps 3 and 5 in FIG. 5, the source code of Plug-and-Play diffusion features is used. In some cases, SD2.1 is used as the generation backbone. In some examples, the resolution size of the generation process is set as 768×768 and a sampling step of 50 is used. The complete process (i.e., steps 1 to 5 in FIG. 5) takes about 60 seconds with single RTX3090 (VRAM 24 GB) GPU.

An exemplary embodiment of the present disclosure is configured to measure text-alignment and image-alignment using CLIP scores. In some cases, text-alignment computes the cosine similarity between the CLIP embedding of the generated image and the CLIP embedding of the text prompt. In some cases, a standard image-alignment metric is adapted to generate multiple concepts. In some cases, the adapted image-alignment metric includes computing cosine similarity between visual embeddings from designated concept regions and the embeddings of corresponding target concepts.

According to an exemplary embodiment, the image generation model of the present disclosure is able to successfully generate the custom concepts even when prompted to generate interactions between the concepts. In some cases, the image generation model can generate custom concepts without mixing or missing concepts while accurately reflecting the given text prompt.

In some examples, the image generation model of the present disclosure outperforms existing techniques in text-similarity and image-similarity scores which indicates that the generated images depict enhanced quality in both text semantic alignment and concept appearance preservation. In some cases, the image generation model generates custom images that depict an improved text match (i.e., alignment with the given text prompt), an improved concept match (i.e., inclusion of the target concepts), and an improved realism (i.e., overall quality and realism) compared to existing techniques.

Embodiments of the present disclosure are able to customize real images. In some cases, the image generation model of the present disclosure is applied to real image editing by substituting the generated template images with real images. Accordingly, the image generation model is able to edit a real-world image with multiple custom concepts. In some cases, the image generation model can accurately inject the appearance and attributes of the target concepts into the existing objects in the real image.

According to an exemplary embodiment, the image generation model is configured to adapt to a low-rank adaptation (LoRA) fine-tuning. LoRA (Low-Rank Adaptation) fine-tuning is a method of efficiently adapting pre-trained models to new tasks by adding and training low-rank decomposition matrices, thereby significantly reducing computational and memory costs compared to traditional fine-tuning methods. In some cases, a LoRA-based fine-tuning is used, where a value of ΔW is updated such that W_{new}=W+ΔW.

Accordingly, embodiments of the present disclosure include a method to generate high-fidelity images which contain multiple custom concepts. In some cases, the image generation model of the present disclosure fuses multiple personalized single-concept models during the sampling stage without any additional optimization process. In some cases, the generated images include a plurality of custom concepts, while accurately depicting complex interactions between the custom concepts. In some examples, the image generation model is applied to customize real-world images and be easily extended to leverage efficient LoRA fine-tuning.

FIG. 12 shows an example of a computing device 1200 according to aspects of the present disclosure. According to some aspects, computing device 1200 includes processor 1205, memory subsystem 1210, communication interface 1215, I/O interface 1220, user interface component 1225, and channel 1230.

In some embodiments, computing device 1200 is an example of, or includes aspects of, the image processing apparatus described with reference to FIG. 4. In some embodiments, computing device 1200 includes one or more processors 1205 that can execute instructions stored in memory subsystem 1210 to obtain an input prompt including a first image element and a second image element; generate, using a first layer of an image generation model, first image features representing the first image element; generate, using a second layer of the image generation model, second image features representing the second image element; and generate, using the image generation model, a synthetic image including the first image element and the second image element based on the first image features and the second image features.

According to some aspects, computing device 1200 includes one or more processors 1205. Processor(s) 1205 are an example of, or includes aspects of, the processor unit as described with reference to FIG. 4. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 1210 includes one or more memory devices. Memory subsystem 1210 is an example of, or includes aspects of, the memory unit as described with reference to FIG. 4. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1215 operates at a boundary between communicating entities (such as computing device 1200, one or more user devices, a cloud, and one or more databases) and channel 1230 and can record and process communications. In some cases, communication interface 1215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1220 is controlled by an I/O controller to manage input and output signals for computing device 1200. In some cases, I/O interface 1220 manages peripherals not integrated into computing device 1200. In some cases, I/O interface 1220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1220 or via hardware components controlled by the I/O controller.

According to some aspects, user interface component(s) 1225 enable a user to interact with computing device 1200. In some cases, user interface component(s) 1225 include an audio device, such as an external speaker system, an external display device such as a display screen, an input device (e.g., a remote-control device interfaced with a user interface directly or through the I/O controller), or a combination thereof. In some cases, user interface component(s) 1225 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image generation comprising:
obtaining a first image element and a second image element of a plurality of custom image elements, wherein the first image element is different from the second image element;
generating, using a first layer of an image generation model, first image features representing the first image element, wherein the first layer is selected based on the first image element;
generating, using a second layer of the image generation model, second image features representing the second image element, wherein the second layer is selected based on the second image element; and
generating, using the image generation model, a synthetic image including the first image element and the second image element based on the first image features and the second image features.

2. The method of claim 1, further comprising:
obtaining a first mask indicating a region of the first image element and a second mask indicating a region of the second image element; and
applying the first mask to the first image features and the second mask to the second image features to obtain first masked features and second masked features, respectively, wherein the synthetic image is generated based on the first masked features and the second masked features.

3. The method of claim 2, wherein obtaining the first mask and the second mask comprises:
obtaining a template image including a first template element corresponding to the first image element and a second template element corresponding to the second image element; and
segmenting the template image to obtain the first mask and the second mask.

4. The method of claim 3, further comprising:
generating template features based on the template image, wherein the first image features and the second image features are based on the template features.

5. The method of claim 3, wherein obtaining the template image comprises:
obtaining an input prompt; and
generating the template image based on the input prompt.

6. The method of claim 1, further comprising:
selecting the first layer and the second layer from a plurality of concept-specific layers based on the first image element and the second image element, respectively.

7. The method of claim 1, further comprising:
combining the first image features and the second image features to obtain combined features representing the first image element and the second image element.

8. The method of claim 1, wherein:
the first image features and the second image features are generated in parallel and are located in a same feature space.

9. The method of claim 1, wherein:
the synthetic image includes customized variants of the first image element and the second image element based on the first image features and the second image features.

10. The method of claim 1, wherein:
the first layer is trained for generating images including the first image element and the second layer is trained separately from the first layer for generating images including the second image element.

11. A method for training an image generation model comprising:
obtaining a training set including a first image depicting a first image element and a second image depicting a second image element; and
training, using the training set, the image generation model to generate a synthetic image including the first image element and the second image element, the training comprising:
training a first layer of the image generation model to generate features representing the first image element using the first image in a first training phase, and
training a second layer of the image generation model to generate features representing the second image element using the second image in a second training phase.

12. The method of claim 11, wherein training the image generation model comprises:
obtaining pre-trained parameters for a layer of the image generation model; and
fine-tuning the pre-trained parameters independently for each of the plurality of custom elements to obtain the plurality of layers.

13. The method of claim 11, wherein training each of the plurality of layers comprises:
training key parameters and value parameters of a cross-attention layer for each of the plurality of custom elements.

14. The method of claim 11, wherein training the image generation model comprises:
computing a diffusion loss; and
updating parameters of the image generation model based on the diffusion loss.

15. The method of claim 11, further comprising:
identifying a plurality of concept categories corresponding to the plurality of custom elements, respectively, wherein the image generation model is trained to generate images including the multiple custom elements based on an input prompt including multiple concepts from the plurality of concept categories.

16. An apparatus for image generation, comprising:
at least one processor;
at least one memory component coupled with the at least one processor; and
an image generation model comprising parameters stored in the at least one memory component and trained to:
select a first layer of an image generation model based on a first image element,
generate, using the first layer, first image features representing the first image element,
select a second layer of an image generation model based on a second image element,
generate, using a second layer of the image generation model, second image features representing a second image element of the input prompt, and
generate a synthetic image including the first image element and the second image element based on the first image features and the second image features.

17. The apparatus of claim 16, further comprising:
a template generation model configured to generate a template image based on an input prompt, wherein the synthetic image is generated based on the template image.

18. The apparatus of claim 17, further comprising:
an inversion model configured to generate template features based on the template image, wherein the first image features and the second image features are based on the template features.

19. The apparatus of claim 16, further comprising:
a mask generation model configured to generate a first mask indicating a region of the first image element and a second mask indicating a region of the second image element, wherein the synthetic image is generated based on the first mask and the second mask.

20. The apparatus of claim 16, wherein:
the first layer and the second layer comprise parallel cross-attention layers of a diffusion model.
